(19) United States
(12) Patent Application Publication
(10) Pub. No.: US 2015/0339038 A1
(43) Pub. Date: Nov. 26, 2015

(54) SYSTEM AND METHOD FOR CAPTURING OCCLUDED GRAPHICAL USER INTERFACES

(71) Applicant: JACOH LLC, Cambridge, MA (US)

(72) Inventors: Jose Alberto Dominguez Illobre, A Coruna (ES); Jason R. Boggess, Cambridge, MA (US)

(73) Assignee: JACOH LLC, Cambridge, MA (US)

(21) Appl. No.: 14/719,134

(22) Filed: May 21, 2015

Related U.S. Application Data
(60) Provisional application No. 62/001,399, filed on May 21, 2014.

(51) Int. Cl. G06F 3/0484; G06F 3/0481

(52) U.S. Cl. CPC G06F 3/04842; G06F 3/04817

(57) ABSTRACT

A computer-implemented system and method for capturing potentially obscured elements of a graphical user interface are disclosed. In one example, the method may include: generating a proxy object within an operating system, wherein the operating system includes a window manager and a graphics framework; registering a target graphical object for capture; instructing the operating system to map a copy of graphical information corresponding to the target object to the proxy object; intercepting graphical information corresponding to the target object; and storing a copy of the graphical information corresponding to the target object.

### CROSS-REFERENCE TO RELATED APPLICATIONS AND PRIORITY CLAIM

This application claims priority to U.S. Provisional Patent Application No. 62/001,399 filed May 21, 2014 and entitled “Systems and Methods for Capturing Graphical user Interfaces of Applications in All Visible States.” The foregoing patent application is hereby incorporated by reference into this application in its entirety

### FIELD

This disclosure relates generally to the field of computer graphics processing. More specifically, this disclosure relates to systems and methods for capturing and/or reproducing graphical objects that are not completely rendered using conventional rendering techniques.

### BACKGROUND

Advances in screen-sharing technology have improved the manner in which users interact with computing devices by allowing for functionalities such as enhanced video entertainment experiences and video conferencing. Technologies such Chromecast, Amazon FireStick, Roku, and Apple TV allows users to stream video or audio to their television from their computer simply by attaching a hardware device to the TV. Other software packages such as Skype, Adobe Connect, Google Hangouts, GoToMeeting, TeamViewer, etc. allow users to broadcast their computer screen and applications to multiple clients. Additional software platforms, such as Remote Desktop Connection, Virtual Network Computing (VNC), and LogMeln, allow users to access and control their computer systems remotely.

However, frequently, users would simply like to display one application at a time instead of their whole desktop to one or more clients. This could be, for example, to protect the user's privacy by not allowing other applications on the desktop to be seen by remote users. In addition, the host user may want to work with other applications while the clients view the target application in the background, without allowing the clients to see what the host user is doing. This could enable a host user to prepare or update a presentation before showing it to the host user's clients, and then switch over to the updated version in real-time.

However, there are several drawbacks associated with conventional systems designed to share one desktop window at a time. By way of example and not limitation, these drawbacks may include undesireable effects such as (i) windows that have been forced to render as topmost may occlude the target window; (ii) windows that move off-screen may become clipped; and/or (iii) windows that are captured from the desktop are subject to poor transparency handling and edge effects.

The following presents an overview of the state of the art prior to the advent of the invention disclosed herein.

Three-dimensional computer graphics use software and hardware to create realistic two-dimensional images of three-dimensional objects. Creating a realistic two-dimensional image of a three-dimensional object starts with a mathematical model that defines the shape of an object in three dimensions. This includes “flat” objects, which may have no depth of their own, but which exist in a three dimensional environment. For example, consider a sheet of cardboard. When laid flat on a table, it has negligible thickness and its position and size can be defined with two-dimensional coordinates. However, if one corner is lifted off the table, three-dimensional coordinates are required to define its position and size, even though its thickness hasn't changed.

Once the mathematical model is created to define the shape of an object in three dimensions, one or more textures are applied to the surface of the three-dimensional object. A texture is a composite of individual elements, sometime called texels, arrayed in two dimensions. A texture can define color, texture, lighting, or multiple other graphical features for a particular position within the array of the texture. The simplest and most important embodiment of a texture is a two-dimensional image, such as a bitmap or raster image. For simplicity, this specification will refer to textures as images. However, one having ordinary skill in the art will understand that all references herein to “images” includes all types of textures, including future technologies incorporating textures and texture-wrapping technology.

When the image is applied to the surface of the three-dimensional object, some of the texels are assigned to vertices of the three-dimensional object. The position of the remaining texels is interpolated based on the position of the assigned texels. Based on the surface geometry of the three-dimensional object, some of the texels may be distorted during the application process. For example, texels farther away from the viewer's perspective within the model space may shrink relative to closer texels to appear farther away. Multiple images may be applied to achieve different effects, including but not limited to surface roughness, lighting, shading, color, transparency, etc. The process of applying the image to the three-dimensional object is also known in the art as “mapping” the image to the three-dimensional object or “wrapping” the image onto the three-dimensional object.

Within a graphical user interface, all of the graphical objects within the graphical environment are composited by a window manager. One example of a window manager is the Desktop Window Manager contained within some versions of the Microsoft® Windows® operating system. Another example is the X Window Manager, which runs on top of the X Window System, a windowing system mainly used on Unix-like operating systems. The foregoing are merely a few examples of commercial window managers and those having ordinary skill in the art will recognize that the processing and techniques described herein may be suitably accomplished by other currently existing, or subsequently developed, window managers. Compositing graphical objects is the process of interpreting where the graphical objects should appear relative to one another within the three-dimensional graphical environment and determining which portions of each graphical object should be visible to the user. For example, a portion of a graphical object may be hidden behind another graphical object or a portion may be off the visible portion of the desktop.

Specific tasks relating to applying images and shading may handled by a graphics framework. A graphics framework is a collection of instructions and data. In some embodiments, a graphics framework may be organized as a “pipeline.” In a pipeline structure, the output of each component of the pipeline is restricted to acting as an input for a sequential component. A pipeline arrangement may include, without limitation, vertices, indices, images, shaders, and input layers. One example of a graphics framework is Microsoft's DirectX platform. Another example is the OpenGL platform. Of course, those having ordinary skill will appreciate that other suitable graphics frameworks may be used without deviating from the teachings of the instant disclosure. A graphics framework may also be referred to as a library.

There are several conventional techniques used to capture windows from applications running on the Microsoft Windows® operating system. 1) The first approach is to copy the entire graphical data from the virtual desktop using the GDI API, and then select only the pixels that correspond to the window. Using the User32 API and a windows device context handle, the bounds of the target window can be found, and the corresponding screen data copied. This technique is used by applications such as Google Hangouts and Adobe Connect to capture individual windows.

Unfortunately, this approach presents many problems. If a window is partially or fully off-screen, none of the off-screen data will be captured, and the corresponding buffer will be missed (see FIG. 1). This method also fails if a window is “always on top” of the other window or has a higher z-index, as the other window will appear in the screen capture above the target window (see FIG. 2).

2) Another conventional technique uses the BitBlt API to grab the pixel data by retrieving the Device Context of a given Window, or using the PrintWindow API. Most applications do not implement the PrintWindow message call correctly leaving images of windows rendered with incorrect transparencies or missing elements (see FIG. 3).

Skype uses a combination of techniques 1) and 2)—1) for when the window is wholly on-screen and 2) for when the window is partially off-screen.

3) A third conventional approach emulates an additional monitor attached to a computer. A virtual display device is attached to the desktop, desired windows are moved to that “invisible” virtual monitor, and then their graphical data is captured. Since the virtual display is not visible to the user, it is possible to move windows around without the user noticing. AirDisplay, ZoneOS, and Intellegraphics have commercialized this technique of creating Virtual Display Drivers

However, there are several drawbacks to the virtual display driver approach. First, it creates invisible space off to the side of the user's desktop in which the user could accidently move a window or the mouse, causing confusion for the user. It also does not solve the problem of capturing windows that are larger than the virtual display, and has all the drawbacks of method 2) when it comes to windows on top and border clipping.

4) A fourth method employed by Air Squirrel's Slingshot application uses a buffer copy to get data in the graphics card. As windows are composited, a snapshot of the buffer is taken before a target window can be cropped or drawn over. This has two main disadvantages. First, since the window itself is not captured, but, rather, only a slice of the desktop composite, edges of the desktop can be seen for a brief moment when resizing or moving the window. Second, this method does not support transparencies correctly since graphics are captured during the composite step, and transparent windows will include a portion of the desktop background.

In conclusion, conventional technology for capturing a specific desktop object (e.g., a window, an icon, a task bar element, etc.) are characterized by one or more of the following limitations: 1) the inability to capture windows that are partially obscured by another window or partially outside the screen, and/or 2) the inability correctly handle window transparencies.

As noted above, although a window 200 and other graphical objects have zero thickness, they can be manipulated in three axes within the three-dimensional graphical environment. FIG. 3 is an illustration of several two-dimensional windows 300 rotated into three-dimensional orientations. The final image, as composited by the window manager, obscures portions of some of the windows behind other windows. The obscured windows 302 include a representation of a desktop window 304. The desktop window 304 is normally the top-level window; it defines the visible area within which all other windows, or portions of them, are displayed. In FIG. 3, a representation of the normal (flat) desktop window 304 is displayed three-dimensionally within the true desktop window 306. This serves to illustrate the concept that a graphical representation of a window can be mapped to second window.

FIG. 4 is an illustration of a captured image of a window 400 illustrating how a portion of the window 402 is eliminated from the image capture because it is off the visible portion of the desktop window, in accordance with prior art GUI capturing techniques. In this example, the left side of the window is to the left of the left-most side of the screen, resulting in a portion of the left side of the window to not appear during a window GUI capture.

FIG. 5 is an illustration of a captured image of a window 500 illustrating how a portion 502 of the window is eliminated from the image capture because it is partially obscured by another window, in accordance with prior art GUI capturing techniques.

FIG. 6 is an illustration of a captured image of a window 600 illustrating how the color of the title-bar 602 failed to render properly during capture, in accordance with prior art GUI capturing techniques.

FIG. 7 is an illustration of a captured image of a window 700 illustrating how the transparency of the title-bar 702 failed to render properly during capture, in accordance with prior art GUI capturing techniques.

### The Windows® Desktop Window Manager

Since Windows Vista, Windows uses the Desktop Window Manager (DWM) to render its graphical interface. DWM is a compositing window manager. In this model, windows are rendered to an off-screen buffer. Then, DWM uses these buffers to create a visual output for the OS Graphical user interface using Direct3D. (See FIG. 4 for an example of the preview functionality).

This level of indirection allows for a great flexibility on how to compose the output of each application in the system to create the visual output as seen in the monitor. One such example of this technology is the Flip 3D effect for Windows 7, which is able to display all windows to the user—even if those windows are currently minimized or partially off-screen (see FIG. 5)

Windows provides documented functions to partially access this functionality with DwmRegisterThumbnail. However, as explicitly stated in the documentation, these functions do not give the possibility of implementing applications like Flip 3D, as they do not give access to the Direct3D image of application windows. Since Windows 8, it is possible to directly duplicate the output of a given adapter (video card) and access it as a Direct3D image. However, this does not give access to the individual window graphics, but only to the final, rendered output of the view of each monitor.

### Existing Wrappers Around the Windows® Desktop Window Manager

Since DWM uses Direct3D to composite the desktop, intercepting all calls to the Direct3D subsystem provides the ability to keep a record of all the resources requested by a given application (including DWM). Copies of the relevant resources can be then created as shared resources to be accessed by a second process that will in turn manipulate these resources (e.g., saving the resource to a file to create a screenshot for a window).

It has been shown that functions exist to access the off-screen buffers of the windows being composed in the desktop. This approach has been scarcely pursued, although one success case has been reported for Windows Vista and WPF/Direct3D applications only. In this post, the author uses DLL entry points from the dwmapi.dll library to retrieve a Direct3D 9 shared surface for a window handle. This surface can then be manipulated by the program calling the entry points to retrieve the graphical data.

However, this approach only works in Vista and for WPF/Direct3D applications, indicating that these entry points only work with the surfaces shared between DirectX based applications and DWM. This fits with the explanation, by a Microsoft developer, of how DWM handles window composition depending on how the rendering mechanism the window uses: “DirectX window redirection is handled by having the DirectX system, when it's determining what surface to provide the app with to render to, make calls to the DWM in order to share a surface between the DirectX client application process, and the DWM processes this “shared surface[ . . . ]”

However, the foregoing approach does not work in Windows 7 and above because the surfaces returned by the function are no longer Direct3D 9 surfaces, but rather, shared DXGI (Direct3D 10 or above) surfaces, corresponding with the new releases of Direct3D (Direct3D 10 was released in Vista, and Direct3D 11 in Windows 7).

Another proposed alternative can be found here https://github.com/notr1ch/DWMCapture. In this case, the author uses the undocumented entry point DwmDxGetSharedSurface, from user32.dll, under Windows 7. This function is, in fact, called from the entry point 100 of dwmapi.dll. This approach does not work under Windows 8 and higher, to retrieve the shared surface of Direct3D/WPF windows.

Accordingly, systems and methods for overcoming one or more of the foregoing drawbacks of conventional technology are needed.

### SUMMARY

A computerized method is presented for capturing occluded graphical user interfaces. In one example, the method may include generating a proxy object within an operating system, where the operating system includes a window manager and a graphics framework, registering a target object, instructing the operating system to map graphical information corresponding to the target object to the proxy object, intercepting the graphical information corresponding to the target object, and storing a copy of the graphical information corresponding to the target object.

In another example, the method may also include exporting the stored copy of the graphical information corresponding to the target object. In another example, the method may also include inserting instructions into the operating system to create the proxy object, register the target object, instruct the operating system to map graphical information corresponding to the target object to the proxy object, intercept the graphical information corresponding to the target object, and store the copy of the graphical information corresponding to the target object.

In another example, the proxy object is a top-level window within a graphical user interface (GUI). In another example, the proxy object is a ghost window.

In another example, the ghost window includes a graphical object which includes a ghost-window client-space texture and ghost-window vertex information, where the ghost-window vertex information includes a position of the ghost window and a size of the ghost window and the position of the ghost window and the size of the ghost window define the ghost window to be at least partially within a visible area of a display device.

In another example, the ghost-window also includes ghost-window shader information, which defines a transparency of the ghost window and where the transparency of the ghost window is greater than 50% and less than 100%. In another example the transparency of the ghost window is greater than 99%.

In another example, registering the target object comprises adding a unique identifier for the target object to a target registry, wherein the target registry comprises a list of unique identifiers.

In another example, instructing the operating system to map graphical information corresponding to the target object to the proxy object includes generating a location for the target object within the ghost window and generating a size for the target object within the ghost window where the location for the target object within the ghost window and/or the size for the target object within the ghost window is/are unique.

In another example, intercepting the graphical information corresponding to the target object includes copying a function call from the window manager to the graphics framework to a capture buffer and identifying the graphical information corresponding to the target object within the function call from the window manager to the graphics framework, based on a unique position within ghost window and/or a size of the target object within the ghost window.

In another example, the graphical information corresponding to the target object comprises an image corresponding to the target object. In other examples, computer systems and non-volatile memory to implement the above methods are also disclosed.

### BRIEF DESCRIPTION OF THE DRAWINGS

FIG. 1 is a block diagram of a computing system for use in capturing graphical user interfaces, in accordance with one example of the present disclosure.

FIG. 2 is a diagram of a window from a graphical user interface illustrating the elements used to draw a window in a three-dimensional graphical environment, in accordance with one example of the present disclosure.

FIG. 3 is an illustration of a graphical user interface showing several two-dimensional windows rotated into three-dimensional orientations, illustrating one example of how a window manager can manipulate a window image in a three-dimensional graphical environment, in accordance with prior art techniques.

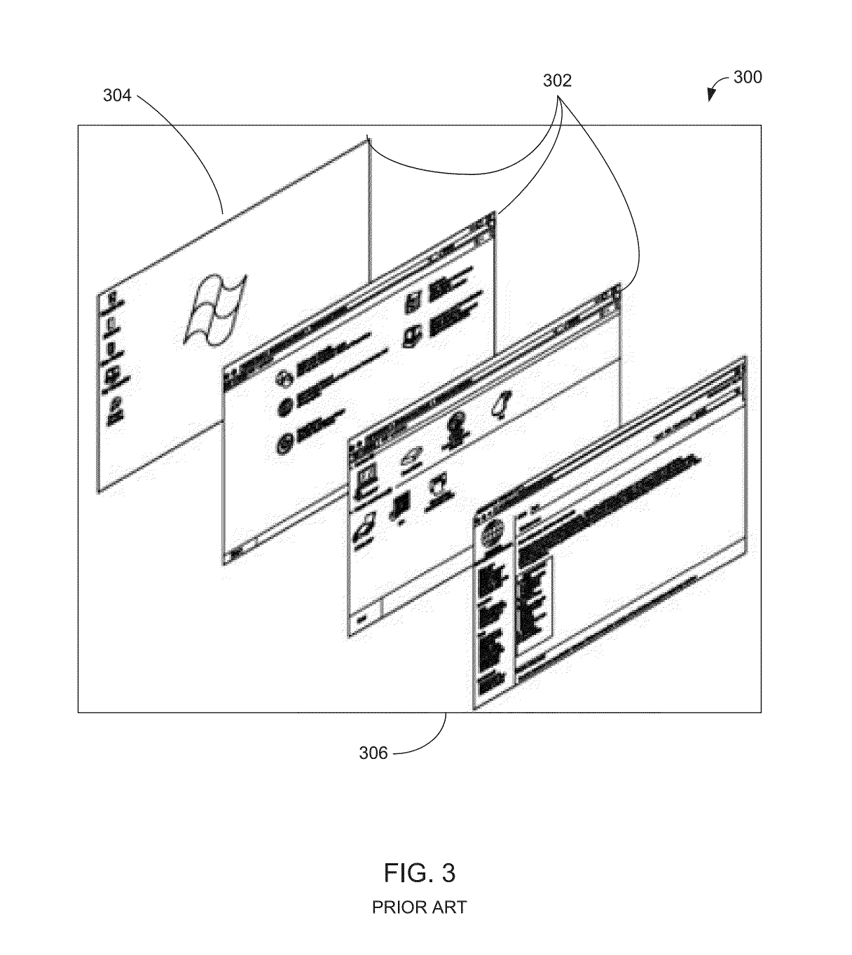

FIG. 4 is a prior-art illustration of a captured image of a window illustrating how a portion of the window is eliminated from the image capture because it is off the visible portion of the desktop, in accordance with prior art techniques.

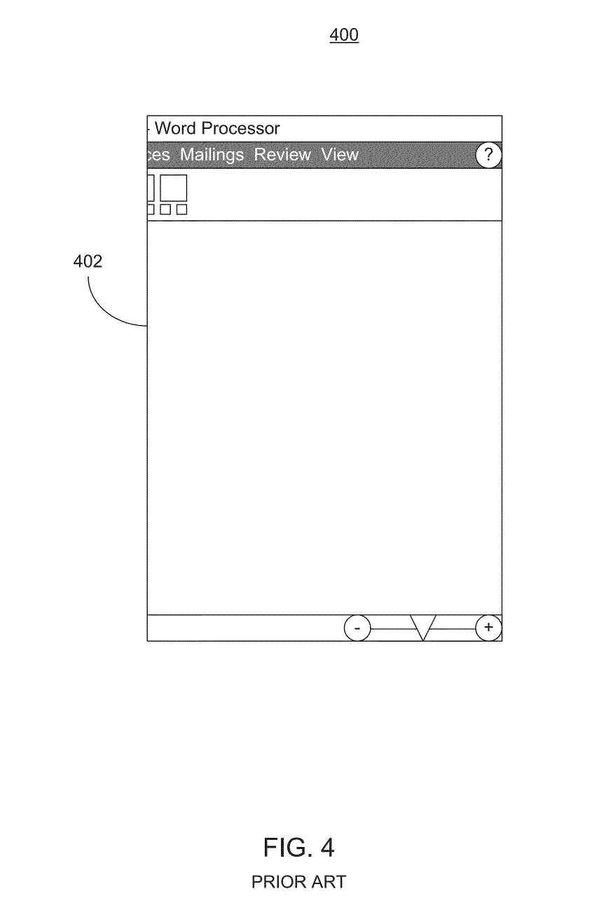

FIG. 5 is a prior-art illustration of a captured image of a window illustrating how a portion of the window is eliminated from the image capture because it is partially obscured by another window, in accordance with prior art techniques.

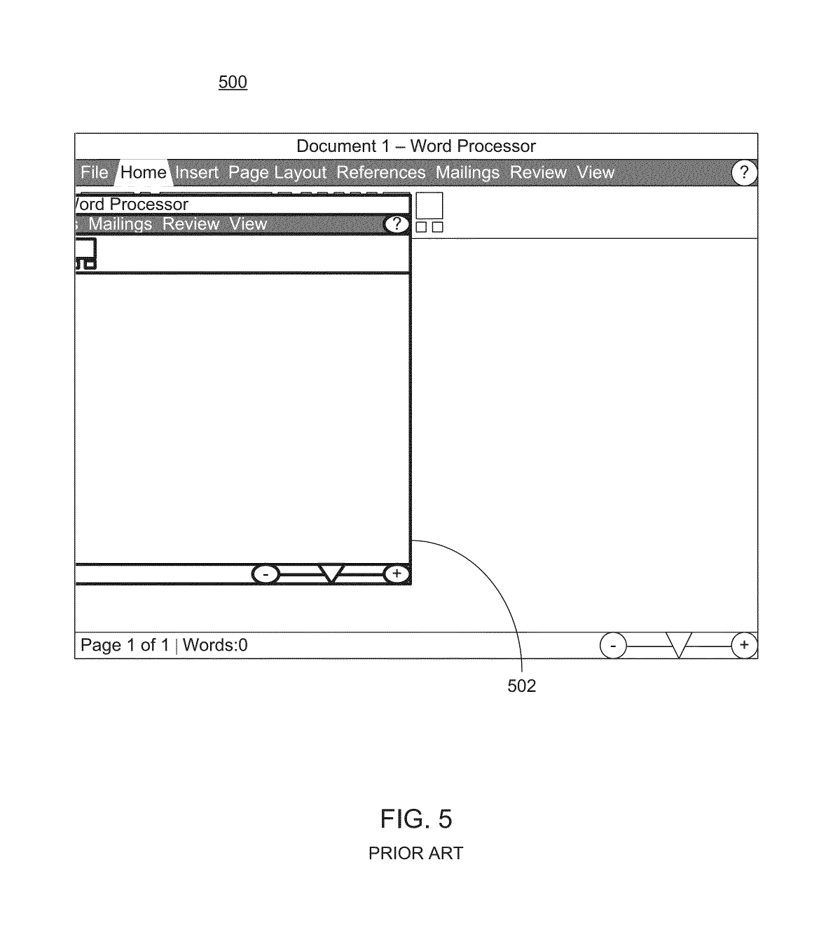

FIG. 6 is a prior-art illustration of a captured image of a window illustrating how the color of the title-bar failed to render properly during capture, in accordance with prior art techniques.

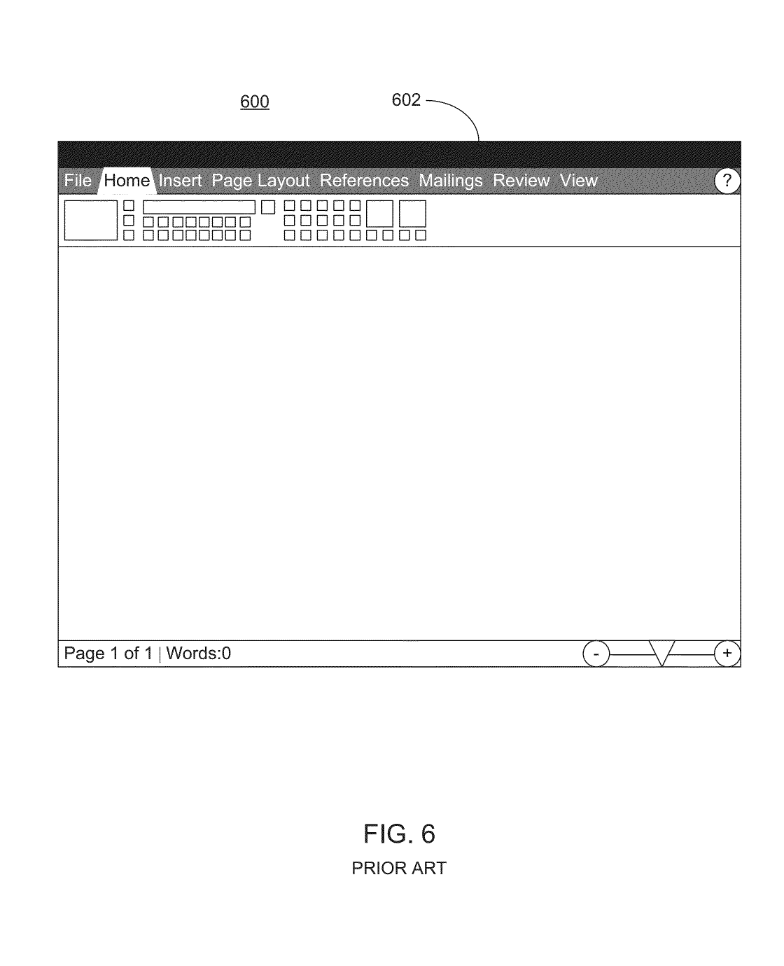

FIG. 7 is a prior-art illustration of a captured image of a window illustrating how the transparency of the title-bar failed to render properly during capture, in accordance with prior art techniques.

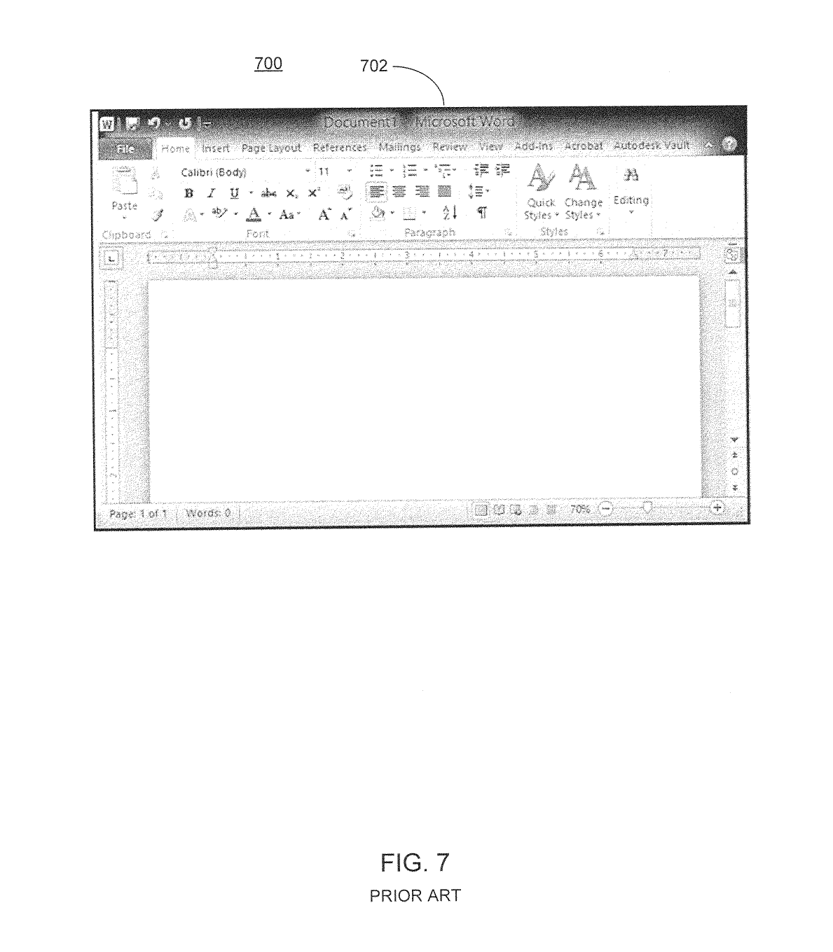

FIG. 8 is a block diagram showing software and hardware components used to implement a three-dimensional graphical environment within a computing system and software and hardware components used to accurately capture objects of the graphical user interface regardless whether they are occluded, in accordance with one example of the present disclosure.

FIG. 9 is a block diagram of software components and data types illustrating the prior art to draw an object in a three-dimensional graphical environment, in accordance with one example of the present disclosure.

FIG. 10 is a block diagram of software components and data types illustrating how to draw an object in a three-dimensional graphical environment and then map that object to a ghost window, in accordance with one example of the present disclosure.

FIG. 11 is a block diagram of software components and data types illustrating how to draw an object in a three-dimensional graphical environment, map that object to a ghost window, and capture an accurate image of the object, in accordance with one example of the present disclosure.

FIG. 12 is a chronological diagram of software components illustrating how data is passed between the software components to draw an object in a three-dimensional graphical environment, map that object to a ghost window, and capture an accurate image of the object, in accordance with one example of the present disclosure.

FIG. 13 is a flow chart illustrating one embodiment of a method for capturing an accurate image of an object, in accordance with one example of the present disclosure.

FIG. 14 is a flow chart illustrating one embodiment of a method for capturing an accurate image of an object, in accordance with one example of the present disclosure.

FIG. 15 is a flow chart illustrating one embodiment of a method for capturing an accurate image of an object, in accordance with one example of the present disclosure.

FIG. 16 is a flow chart illustrating one embodiment of a method for capturing an accurate image of the object, in accordance with one example of the present disclosure.

### DETAILED DESCRIPTION

To facilitate an understanding of the principals and features of the disclosed technology, illustrative embodiments are explained below. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It must also be noted that, as used in the specification and the appended claims, the singular forms “a,” “an” and “the” include plural referents unless the context clearly dictates otherwise.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

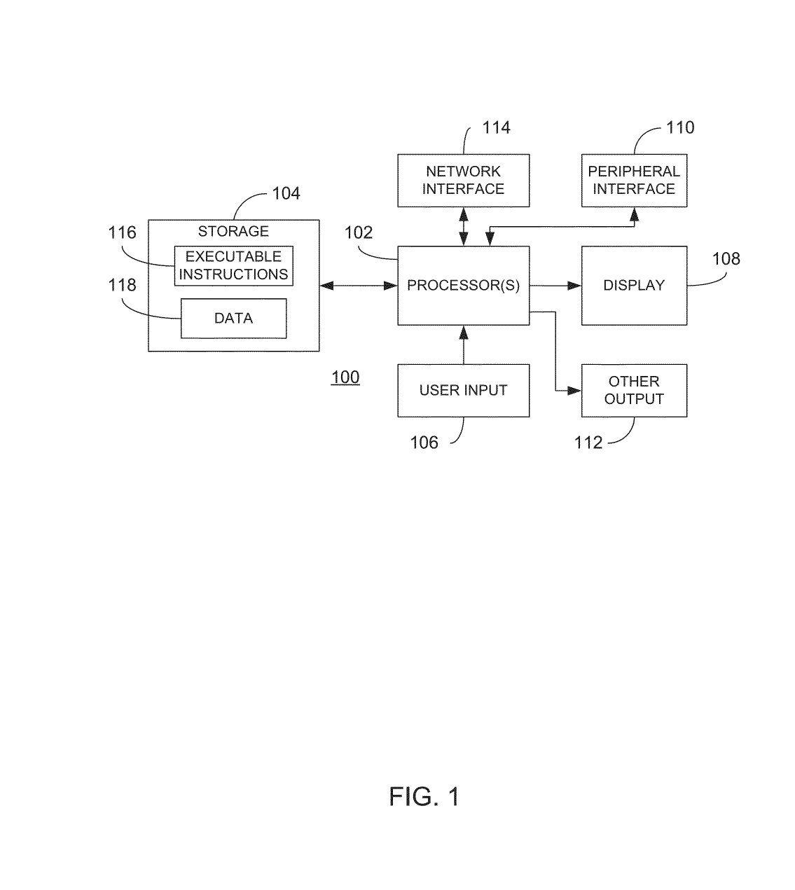

Referring now to the Figures, in which like reference numerals represent like parts, various embodiments of the computing devices and methods will be disclosed in detail. FIG. 1 is a block diagram illustrating one example of a computing device 100 suitable for use in capturing a graphical user interface in accordance with one or more embodiments of the instant disclosure.

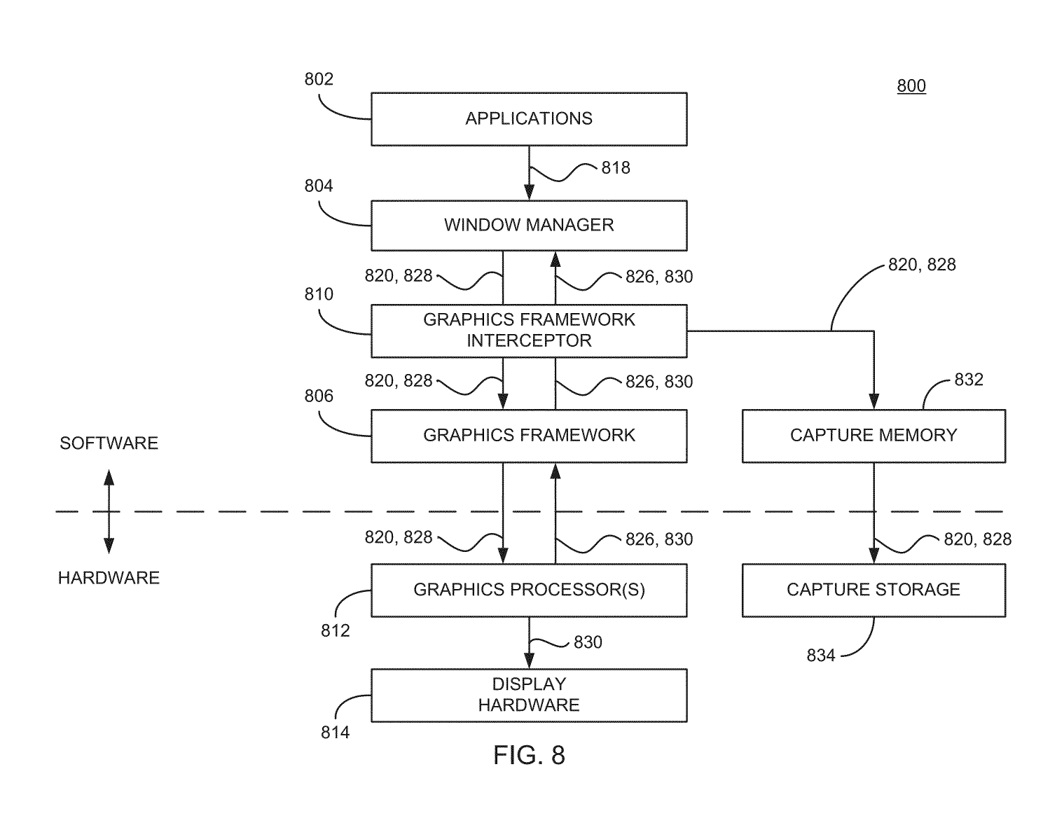

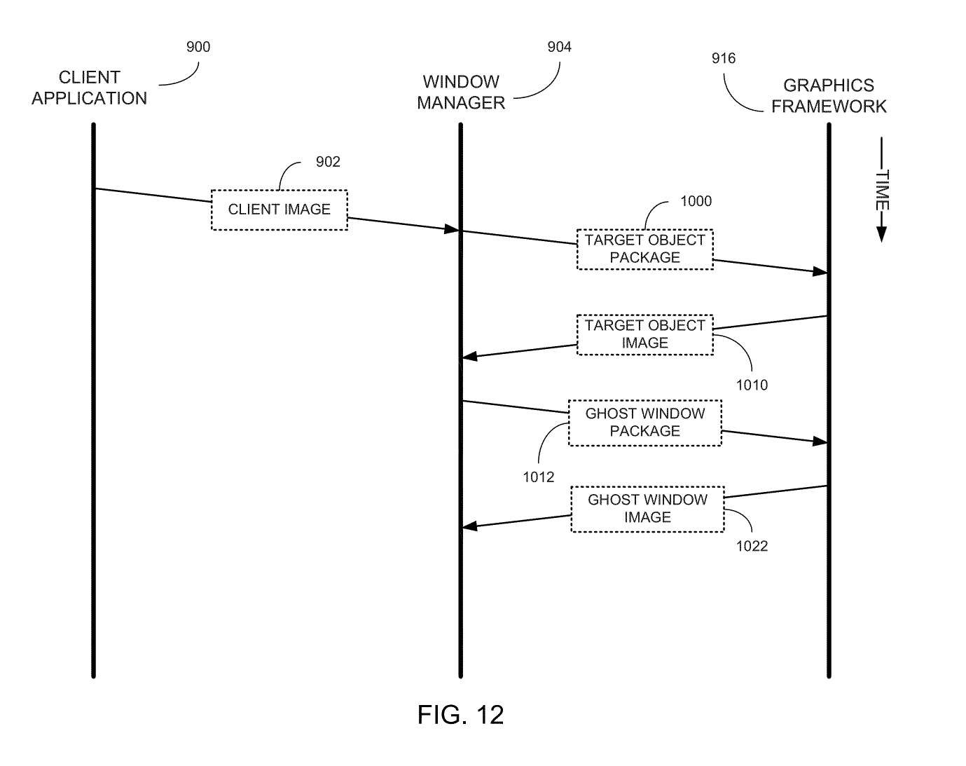

FIG. 1 illustrates a representative computing device 100 that may be used to implement the teachings of the instant disclosure. The device 100 may be used to implement, for example, one or more components of the system shown in FIGS. 8-11, as described in greater detail below. As another example, the device 100 may be used to implement the methods of FIGS. 12-16, as described in greater detail below. The device 100 includes one or more processors 102 operatively connected to a storage component 104. The storage component 104, in turn, includes stored executable instructions 116 and data 118. In an embodiment, the processor(s) 102 may include one or more of a central processing unit (CPU), microprocessor, microcontroller, digital signal processor, co-processor, graphics processing unit (GPU), general purpose graphics processing unit (GPGPU) or the like, each of which may include one or more cores, or combinations thereof capable of executing the stored instructions 116 and operating upon the stored data 118. Likewise, the storage component 104 may include one or more devices such as volatile or nonvolatile memory including but not limited to random access memory (RAM) or read only memory (ROM). Further still, the storage component 104 may be embodied in a variety of forms, such as a hard drive, optical disc drive, floppy disc drive, flash memory, etc. Processor and storage arrangements of the types illustrated in FIG. 1 are well known to those having ordinary skill in the art. In one embodiment, the processing techniques described herein are implemented as a combination of executable instructions and data within the storage component 104.

As shown, the computing device 100 may include one or more user input devices 106, a display 108, a peripheral interface 110, other output devices 112, and a network interface 114 in communication with the processor(s) 102. The user input device 106 may include any mechanism for providing user input to the processor(s) 102. For example, the user input device 106 may include a keyboard, a mouse, a touch screen, microphone and suitable voice recognition application, or any other means whereby a user of the device 100 may provide input data to the processor(s) 102. The display 108 may include any conventional display mechanism such as a cathode ray tube (CRT), flat panel display, projector, or any other display mechanism known to those having ordinary skill in the art. In an embodiment, the display 108, in conjunction with suitable stored instructions 116, may be used to implement a graphical user interface. Implementation of a graphical user interface in this manner is well known to those having ordinary skill in the art. The peripheral interface 110 may include the hardware, firmware and/or software necessary for communication with various peripheral devices, such as media drives (e.g., magnetic disk, solid state, or optical disk drives), other processing devices, or any other input source used in connection with the instant techniques. For example, the peripheral interface may be a Universal Serial Bus (USB). Likewise, the other output device(s) 112 may optionally include similar media drive mechanisms, other processing devices, or other output destinations capable of providing information to a user of the device 100, such as speakers, LEDs, tactile outputs, etc. Finally, the network interface 114 may include hardware, firmware, and/or software that allows the processor(s) 102 to communicate with other devices via wired or wireless networks, whether local or wide area, private or public, as known in the art. For example, such networks may include the World Wide Web or Internet, or private enterprise networks, as known in the art.

While the computing device 100 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations of the device 100 may include a greater or lesser number of components than those illustrated. Once again, those of ordinary skill in the art will appreciate the wide number of variations that may be used is this manner. Further still, although a single computing device 100 is illustrated in FIG. 1, it is understood that a combination of such computing devices may be configured to operate in conjunction (for example, using known networking techniques) to implement the teachings of the instant disclosure.

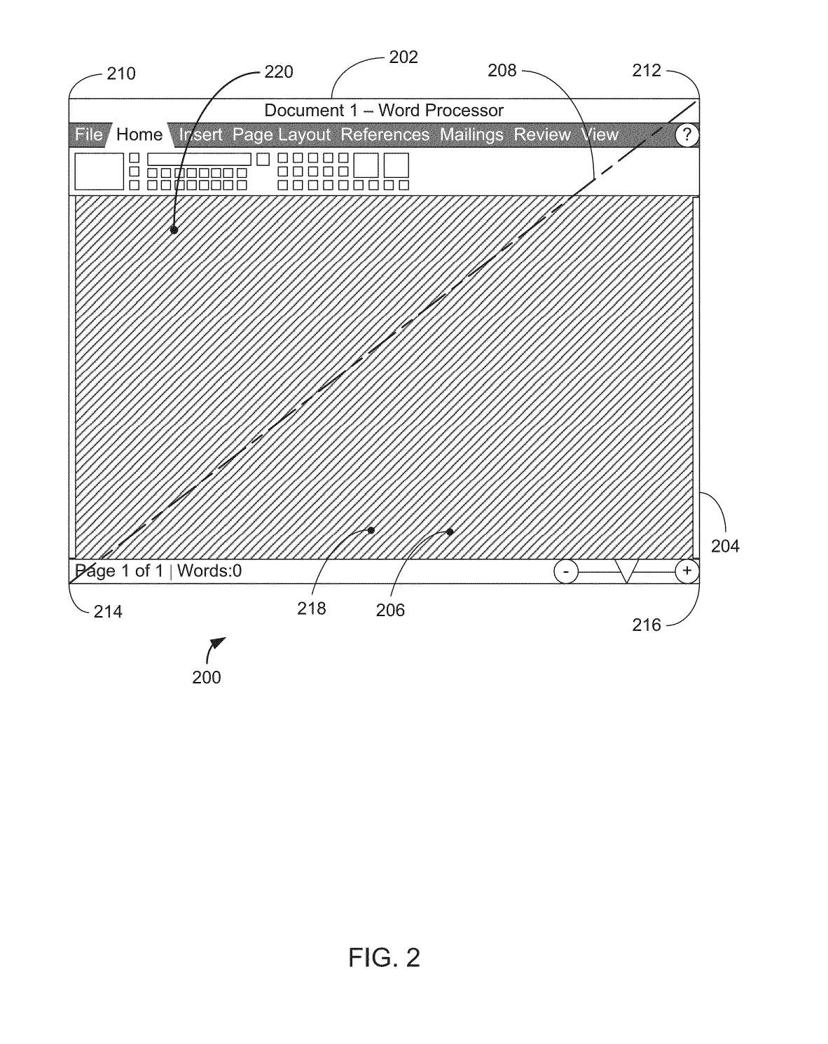

FIG. 2 is a diagram of a window 200 from a graphical user interface. Windows are the most common graphical objects within a graphical user interface. Other graphical objects may include, without limitation, icons, widgets, task bars, and status bars. FIG. 2 illustrates certain elements used to draw a window in a three-dimensional graphical environment. At the top of the window 200 is a title bar 202, which may be a component of the window boarder 204. The title bar 202 and the window boarder 206 are examples of window decorations which may be drawn around the window 200 to visually differentiate it from other graphical objects within the graphical environment. The area of the window 200 not devoted to widow decorations is referred to herein as the “client space” 206 (indicated by the cross-hatched area). Graphical content from the client application is displayed in the client space 206. A window is a simple, zero-thickness object within the three-dimensional graphical environment. Consequently, in some embodiments it can be represented by two triangular polygons. The first triangle 218 is separated from the second triangle 220 by a diagonal line 208 from a first corner vertex 212 of the window to the opposite corner vertex 214. The diagonal line 208 is only shown for clarity; it is not displayed in a real GUI. The first corner vertex 212 and the opposite corner vertex 214 are shared by the first triangle 218 and the second triangle 220. The final vertex of the first triangle 216 and the final vertex of the second triangle 210 complete definition of the window's 200 position and size within the graphical environment.

FIG. 8 is a block diagram showing software and hardware components 800 used to implement one embodiment of a three-dimensional graphical environment within a computing system and also software and hardware components used to accurately capture graphical objects of the graphical user interface regardless of whether or not they are occluded. The software components in this embodiment include a client applications 802, a window manager 804, a graphics framework 806, a graphics framework interceptor 810, and capture memory 832. The hardware components in one embodiment include one or more graphics processors 812, display hardware 814, and capture storage 834. In operation, the applications 802 send client image data 818 corresponding to the client space of each application window to the window manage 804. The window manager 804 then adds information about the window decoration to the client image data 818 to create a client object package 820. For example, the window manager 804 may add a border, title bar, etc. The window manager 804 also defines the position and size of the object. The window manager 804 then sends the client object package 820 to the one or more graphics processors 812 by calling functions from the graphics framework 808. In some embodiments, the client object package 820, client image data 818, or portions thereof may be parameters of the function calls. The one or more graphics processors 812 then use the client object package 820 to generate a two-dimensional image of the object 826. The two-dimensional image of the object 826 is then returned to the window manager 804. In some embodiments, the system may perform multiple iterations of this process. For example, the window manager 804 may then combine the two-dimensional images of several objects into an image of the desktop and use this combined image to send a desktop object package 828 to the one or more graphical processors 806. The one or more graphical processors 806 may then composite this desktop object package 828 into an image of the desktop 830 using the graphics framework 808, as described above. The one or more graphical processors 806 may also export the image of the desktop 830 to the display hardware 814.

The graphics framework interceptor 810 is a software component which intercepts function calls to the graphics framework 806, including the client object packages 820 and desktop object packages 828 sent from the window manager 804 to the one or more graphical processors 806. The intercepted data 820, 828 is then stored in a dedicated capture memory location 832. In some embodiments, the intercepted data 820, 828 may be further stored in a physical storage location 834.

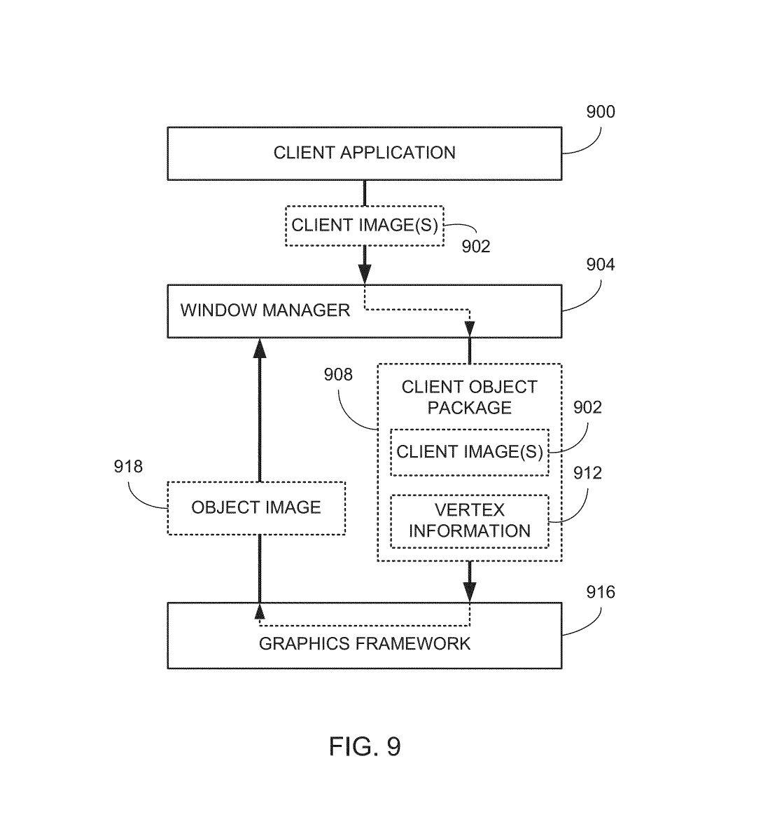

FIG. 9 is a block diagram of software components and data types illustrating a prior art system for drawing an object in a three-dimensional graphical environment. As shown in FIG. 9, a client application 900 transmits a client image 902 to the window manager 904. The client image 902 is the graphical image to be displayed within the client space of a graphical object. The window manager 904 adds additional elements associated with the graphical object to create an object package 908 and delivers the object package 908 to the graphics framework 916. In some embodiments, a client application 900 may transmit multiple client images 902 to the window manager 904 to be composited. For example, some client applications 900 may include several sub-windows and graphical features within the client space. Examples of sub-windows may include navigation panes, document maps, document rulers, page thumbnails, tool bars, menu bares, etc. The client object package 908 includes the client image 902 and vertex information 912. Vertex information 912 includes, at least, 3D coordinates for the vertices. Vertex information may also include the vertices' 3D normal vectors (for shading), their 2D image coordinates, their 3D color vector, lighting parameters, etc. The client object package may also include index information and shader information. Index information includes a list of vertices for the graphical object. Shader information includes information for applying shading effects to the graphical object. For example, shader information might change the transparency of the graphical object or change the lighting of the graphical object.

The graphics framework 916 may include one or more graphical libraries. The graphics framework 916 takes the client object package 908, applies the index information and vertex information 912 to the client object image 902 using one or more graphics processors and returns a single object image 918 to the window manager 904. The window manager 904 then uses the object image 918, along with images for other objects on the desktop, to composite the desktop window. The process then repeats to generate a desktop window package and return a desktop window image.

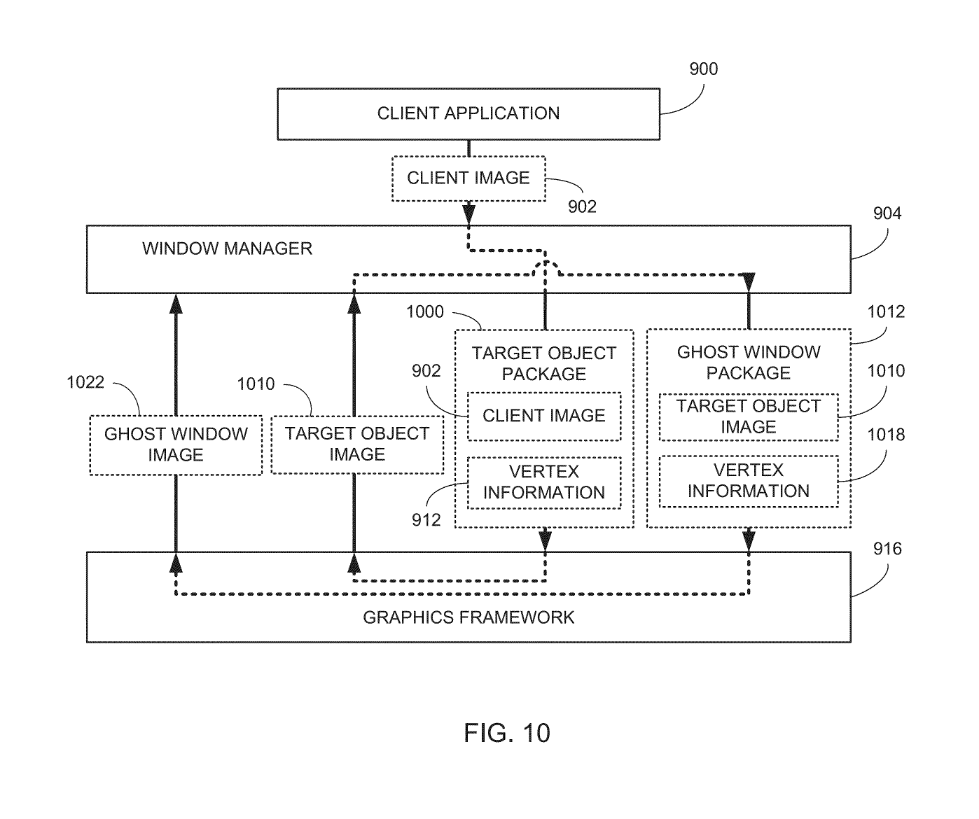

FIG. 10 is a block diagram of software components and data types illustrating how to draw an object in a three-dimensional graphical environment and then map that object to a ghost window, in accordance with one example of the present disclosure. Similar to FIG. 9, the client application 900 transmits a client image 902 to the window manager 904 and the window manager 904 adds additional elements associated with the graphical object to create a target object package 1000 and delivers the target object package 1000 to the graphics framework 916. The target object package 1000 includes the client image 902 and vertex information 912. The graphics framework 916 takes the target object package 1000 and returns a single target object image 1010 to the window manager 904.

Because the window manager 904 is instructed to map the target object to the ghost window, the window manager 904 adds new vertex information 1018, for the target object as-mapped within the ghost window, to the target object image 1010 to generate the ghost window package 1012. The window manager 904 then delivers the ghost window package 1012 to the graphics framework 916. The graphics framework 916 takes the ghost window package 1012 and returns a ghost window image 1022 to the window manager 904. In some embodiments there may be multiple target objects. Accordingly, in these embodiments multiple target object images may composited within the ghost window. The window manager 904 then re-composites the desktop window with the ghost window image incorporated

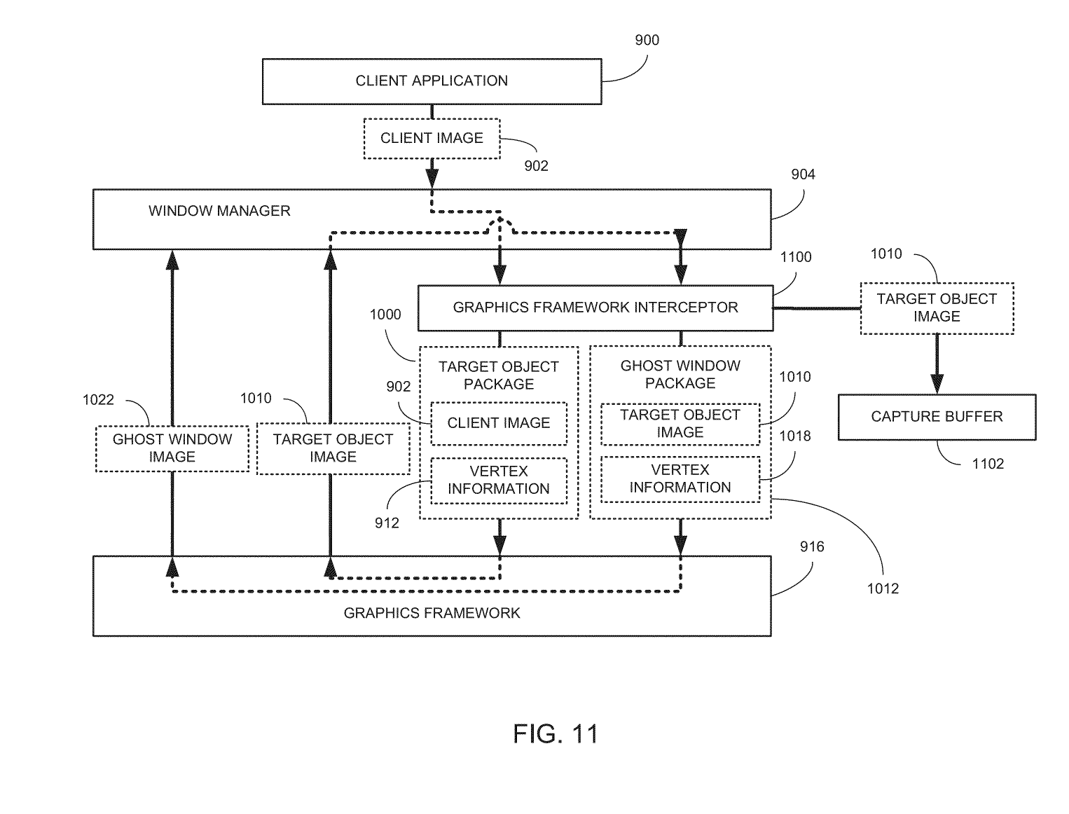

FIG. 11 is a block diagram of software components and data types illustrating how to draw an object in a three-dimensional graphical environment, map that object to a ghost window, and capture an accurate image of the object. The client application 900, window manager 904 and graphics framework 916 behave essentially the same as in FIG. 10. However, in this example, a graphics framework interceptor 1100 is inserted into the data stream between the window manger 904 and the graphics framework 916. The graphics framework interceptor 1100 may intercept all function calls directed to the graphics framework 916, copy the function calls, and forward the function calls, unchanged, to the graphics framework 916. From the intercepted and copied function calls to the graphics framework 916, the graphics framework interceptor 1100 may identify the target object images 1010 based on the vertex information 1018 in the ghost window package 1012. The target object image 1010 may then be exported to a capture buffer 1102.

In one embodiment of the disclosure, the graphics framework interceptor 1100 is a collection of dynamic link libraries (DLLs) encompassing Microsoft Windows Direct3D DLLs. In this embodiment, the graphics framework interceptor 1100 externally exports the same functions as each Direct3D DLL, and internally forwards the function calls to the Direct3D subsystem. In this embodiment, the graphics framework interceptor 1100 acts as a middleman copying the graphical information, e.g. the target object package 1000 and ghost window package 1012, of a window and providing access to this graphical information to a third party application, via an additional API in the Texture-Resolver Library. In one embodiment of the disclosure, the graphics framework interceptor 1100 may replace system files and export the same functions. In another embodiment, the graphics framework interceptor 1100 may be applied by injecting code into the running process, allocating memory in the process, copying data to the target process, and executing a remote procedure call. Graphic library calls are then intercepted by hooking, a process known to those skilled in the art.

In one embodiment of this disclosure, the graphics framework interceptor 1100 may intercept all the calls (including Desktop Window Manager calls) to Direct3D subsystem methods, including, but not limited to ::CreateDevice, ::GetImmediateContext, ::CreateInputLayout, ::PSSetShaderResources, ::IASetVertexBuffers, ::IASetInputLayout, ::IASetIndexBuffer made by the Desktop Windows Management system. In one embodiment of the disclosure, these are called on the Direct3D 10 library. In another embodiment of the disclosure, these are called on the Direct3D 11 subsystem. In another embodiment of the disclosure, these are called on the Direct3D 12 and future versions of the Direct3D library. In another embodiment of the disclosure, calls to one or move Direct3D libraries are intercepted simultaneously to resolve images correctly (as used in Windows 8 prime).

In one embodiment of the disclosure, images are only captured if the library is running inside the Desktop Window Manager process. In another embodiment of the disclosure, the graphics framework interceptor 1100 captures images no matter what process it is in.

In one embodiment of the disclosure, the final images are captured directly. In another embodiment of the disclosure, an entire rendering pipeline, including, but not limited to, vertices, indices, images, shaders, and input layers is captured and stored in memory.

FIG. 12 is a diagram illustrating one example of the chronological flow of data between software components in accordance with one or more embodiments of the instant disclosure. More specifically, FIG. 12 illustrates how data may be passed between the software components as explained in the process detailed above

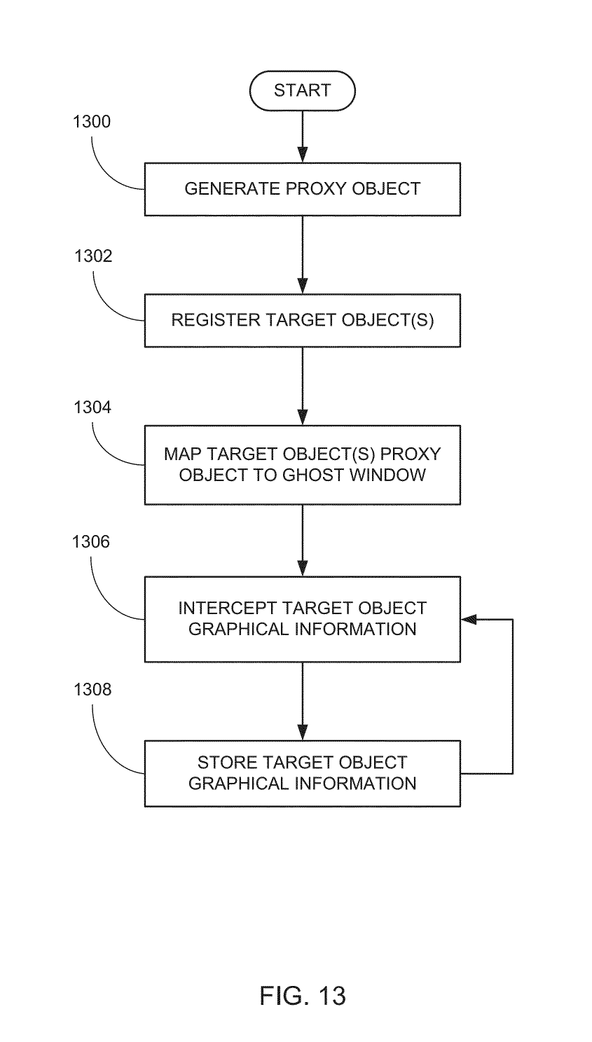

FIG. 13 is a flow chart illustrating one embodiment of a method for capturing an accurate image of an object. At 1300, a proxy object is generated. At 1302, one or more target objects are registered. At 1304, the one or more graphical information corresponding to the one or more target objects is mapped to the proxy object. At 1306, the graphical information corresponding to the one or more target object images are intercepted. At 1308, the graphical information corresponding to one or more target object images are stored and the next iteration of the one or more target object images are intercepted.

In one embodiment of the disclosure, the proxy object is a proxy rendering window, henceforth the “ghost window”. Images corresponding to registered target objects are mapped to the display buffer of the ghost window, so that they appear visibly, at least partially, within the ghost window.

In one embodiment, the DWMRegisterThumbnails call of the DWM API in Windows may be used to map the target images to the ghost window. In another embodiment, the window buffer may be manually copied to another drawing surface, using graphic library APIs (e.g., DirectX, OpenGL, etc.).

In one embodiment, the ghost window may be placed at the top-left corner of the primary screen (position 0, 0). In another embodiment of the disclosure, the ghost window may be placed at the top-left corner of the virtual desktop (top-left coordinate of the left-most display). In another embodiment of the disclosure, the ghost window may be placed underneath standard desktop elements, such as the task bar. In one embodiment of the disclosure, the ghost window may be hidden from the task bar, alt-tab menu, and task manager.

In one embodiment of the disclosure, the ghost window may be “always on top,” allowing for mouse and keyboard pass-through, so that it can never take focus. In another embodiment of the disclosure, the ghost window may be behind all other elements of the desktop so that it is never seen by the user.

In one embodiment of the disclosure, the ghost window is sufficently sized to fit all buffered copies of target windows. In another embodiment of the disclosure, the ghost window may be the same size as a single client screen. In another embodiment of the disclosure, the ghost window may be the exact same size as the virtual desktop.

In one embodiment, the ghost window has a low alpha transparency value (under 1%), such that it is barely visible. In another embodiment of the disclosure, the ghost window may be semi-transparent, but still visible. In still another embodiment of the disclosure, the ghost window may have an alpha of 100% (255 out of 255), such that it is perfectly visible. In another embodiment of the disclosure, copied window buffers may be painted on the window with an alpha transparency of under 100%, such that the window buffers may be blended with the background of the ghost window. In another embodiment of the disclosure, the target window buffers may be semi-transparent and the ghost window may be semi transparent, such that the composition of the two window visuals results in a wholly invisible copy due to integer division. Integer devision rounds the result of mathematical operations to the nearest integer. Thus, the final visibility of the composited ghost window will be rounded down to zero. In one embodiment of the disclosure, a specific graphical object, the “target object,” is registered for capture. In one embodiment, this registration may be accomplished by accessing an API on the graphics framework interceptor and providing the operating system handle (integer pointer) to the target window. In another embodiment of the disclosure, this registration is done by addressing shared memory space that both a client application and the graphics framework interceptor may access and specifying the system handle to the object. In another embodiment of the disclosure, registration is accomplished by sending a system message that is received by the graphics framework interceptor. In another embodiment of the invention, registration may be accomplished by writing to a permanent storage device (e.g., a hard drive, flash drive, etc.) by writing the specified handle to a file. In another embodiment of the disclosure, registration may be performed by broadcasting packets over a computer network with the handle of the desired window to capture.

In one embodiment of the disclosure, a target window that has been previously registered can be deregistered by using another API call on the graphics framework interceptor. In another embodiment, this deregistration can be done using shared memory space. In another embodiment, this deregistration can be done using permanent storage. In another embodiment, this deregistration can be done using system messaging. In another embodiment, this deregistration can be done via a computer network.

In one embodiment of the disclosure, only one target object is registered at a time. In another embodiment, a set number of windows handles can be registered at a given time. In one embodiment of the disclosure, the number of window handles is limited and set by the user. In another embodiment, the number of window handles that can be registered is determined dynamically by available resources on the computing system.

In another embodiment of the disclosure, all graphical objects are considered target objects at any given time, rather than specific windows. In this embodiment of the disclosure, window handles can be registered/deregistered internally by listening to window create, window show, and window close system messages.

In one embodiment of the disclosure, only traditional windows can be target objects. In another embodiment of the disclosure, non-traditional windows, such as those that do not show up in the task bar, the desktop window, the taskbar itself, icons, context menus, popup dialogs, etc. can be target windows.

Due to optimizations in rendering of graphic card libraries (such as DirectX and OpenGL), polygons that are wholly off-screen are fully optimized out, i.e., completely ignored. Polygons that are partially on screen are not ignored, because it is easier computationally to render a triangle partially off-screen than to crop that triangle to a subset of wholly visible triangles.

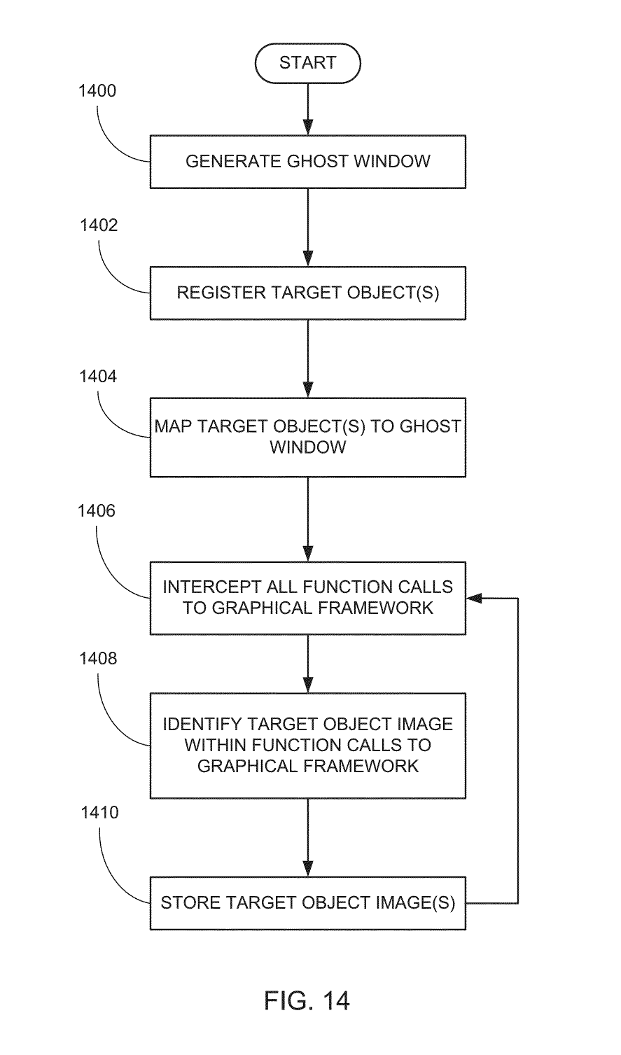

FIG. 14 is a flow chart illustrating another embodiment of a method for capturing an accurate image of the object, including additional detail, in accordance with one embodiment of the instant disclosure. In this embodiment, the proxy object is the ghost window and the graphical information corresponding to the target object is a target object image. At 1400, a ghost window is generated. At 1402, a target object or objects are registered. At 1404, the target objects(s) are mapped to the ghost window. At 1406, all function calls to the graphics framework are intercepted. At 1408, the target object image is identified based on its position and size within the ghost window. At 1410, the target object image is stored and the next iteration of the target object image(s) is intercepted.

Images require special identification techniques because they are drawn collectively (as a series of images) without any identifying information about each individual image. In one embodiment of the disclosure, the target object images are identified based on the position of the target object images within the ghost window. In one embodiment, the target object image's position is uniquely set on the ghost window, and the position and size of the target object image are matched to the registered target window. In another embodiment, the target object image is positioned multiple times onto the ghost window in unique locations to decrease the probability of two images in the rendering pipeline rendering in the same location. In this embodiment, the image at a particular encoded location is compared bit-wise to the other images at the encoded locations for the given target window handle. The image with the highest frequency of matches is chosen.

In another embodiment of the disclosure, a image may be found by using a conventional method of capturing an application's GUI, as described in the background, and comparing the conventional output to that of the image to identify. In another embodiment of the disclosure, general image information from a set of applications is known, and the image to identify may be compared to one of those images in the set.

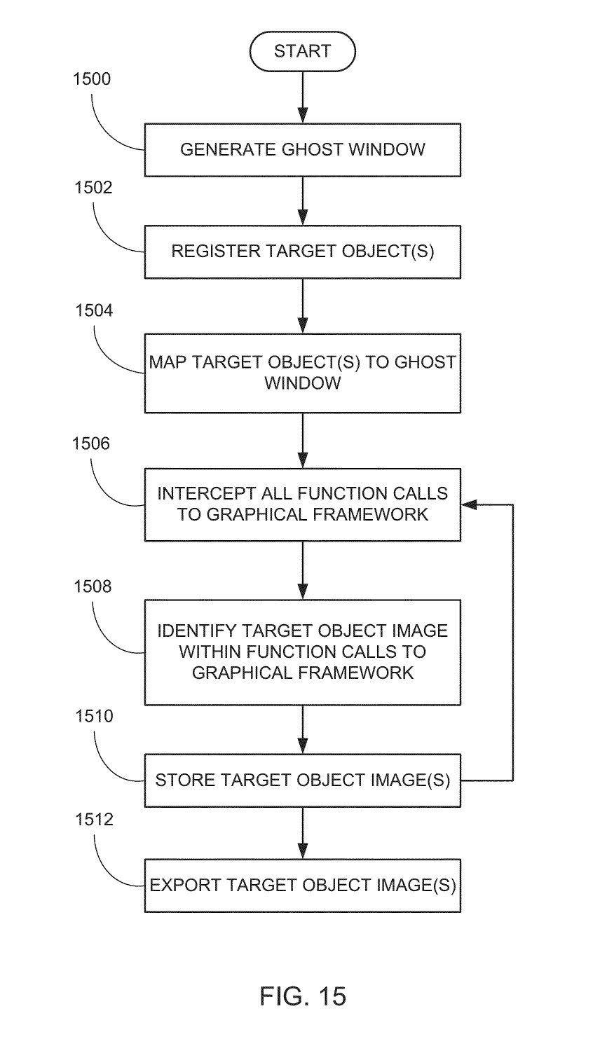

FIG. 15 is a flow chart illustrating another embodiment of a method for capturing an accurate image of the object, including additional detail, in accordance with one embodiment of the instant disclosure. At 1500, a ghost window is generated. At 1502, target object or objects are registered. At 1504, the target objects(s) are mapped to the ghost window. At 1506, all function calls to the graphics framework are intercepted. At 1508, the target object image is identified based on its position and size within the ghost window. At 1510, the target object image is stored and the next iteration of the target object image(s) is intercepted. At 1512, the target object image is exported.

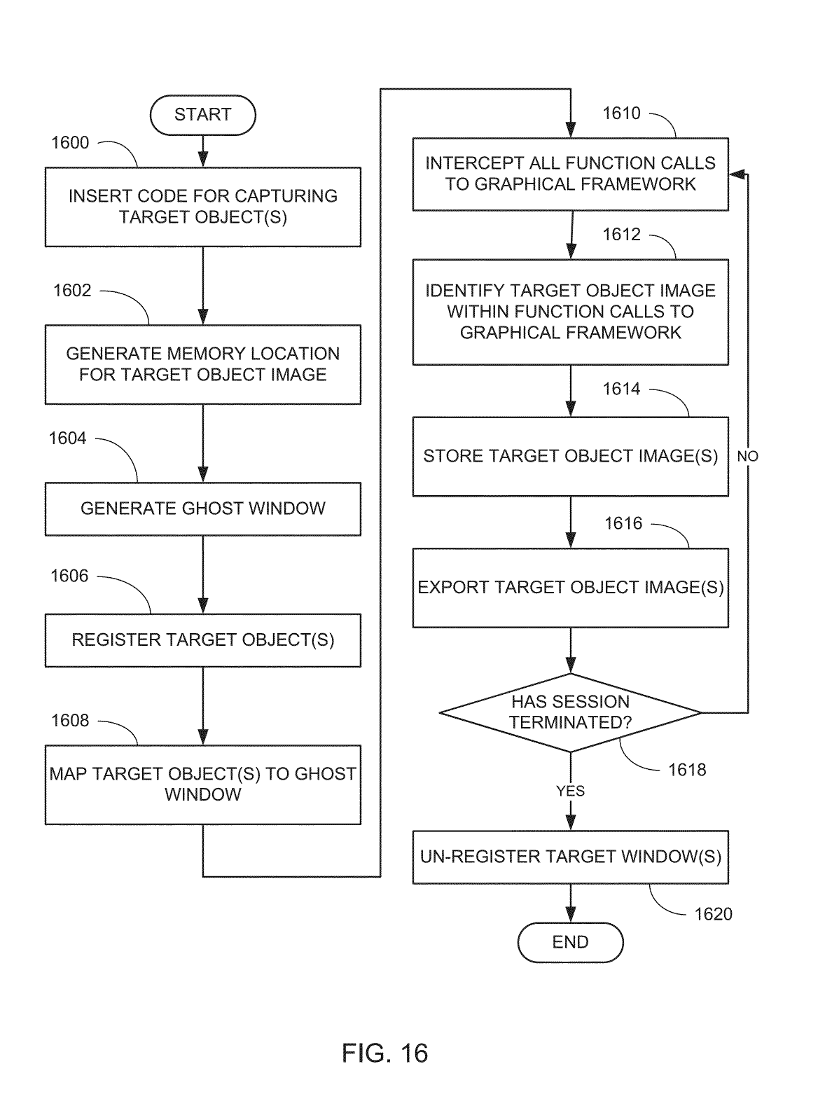

FIG. 16 is a flow chart illustrating another embodiment of a method for capturing an accurate image of the object, including additional detail. At 1600, code is inserted into the operating system to facilitate capturing the target object. At 1602, a memory location is addressed to store the captured target object images. At 1604, a ghost window is generated. At 1606, target object or objects are registered. At 1608, the target objects(s) are mapped to the ghost window. At 1610, all function calls to the graphics framework are intercepted. At 1612, the target object image is identified based on its position and size within the ghost window. At 1614, the target object image is stored and the next iteration of the target object image(s) is intercepted. At 1616, the target object image is exported. At 1618, the system checks if the graphical capturing session is still active or if it has been terminated. If it is still active, the next iteration of function calls to the graphics framework is captured. If the session is terminated, the target window is un-registered at 1620.

Once the image information has been captured, identified, and stored, the systems and methods described herein provide mechanisms for accessing that data. In one embodiment of the disclosure, an API may be provided directly from the graphics framework interceptor. In another embodiment, a client library with a publically-facing API may provide third-party applications access to the shared memory. In another embodiment, access to the shared image memory may be open to anyone on the system. In another embodiment, access to the shared image information requires authentication and the information is encrypted. In another embodiment, a system service is created to start when the operating system starts, and automatically provide APIs to access the requested images. In another embodiment of the disclosure, API access to registering a window handle in the Texture Resolver Library is combined into one client library.

In another embodiment of the disclosure, the Windows® Desktop Window Manager (DWM) API is extended by calling undocumented functions in the DWM API to capture graphical data of a window and rendering to a third-party device context, in conjunction with a GDI window renderer using the GDI32 API. In this embodiment, windows display types may be automatically detected and the corresponding capture type is determined automatically:
(1) A DWM wrapper component extends existing functionality of the DWM API by providing access to undocumented functions in the desktop window manager system in order to capture windows from applications rendered with DirectX.
(2) An API layer copies and stores that display buffer making the information accessible to third-party applications.
(3) A GDI wrapper extends the GDI32 API to capture windows that are rendered with GDI using functions like BitBlt and PrintWindow.
(4) A Window Manager component analyzes a window handle, identifies the window rendering type, and determines the necessary wrapper component (GDI or DWM) to use.
(5) An API layer is provided to allow seamless access to the visual information of a window, given its window handle.

In one embodiment, a combination of undocumented functions (e.g. gdi32.dll function DwmGetRedirectionStyle) and analysis of the results of each capture method is used to determine the render type for each window (GDI or DirectX). In another embodiment of this disclosure, the DWM Capture System captures window graphical information from both GDI and DWM and combines them into a single image that can be accessed through the API.

In some embodiments, the API layer consists of a window handle registration where a window handle is registered and messages to the registry are triggered by updates to the window's graphical display. In other embodiments of this disclosure, the graphical data buffer is returned immediately after the system is given a window handle. In another embodiment, a pointer to memory is surfaced and the data can be read directly from a buffer within the system.

In another embodiment of this disclosure, applications are registered through the API instead of individual windows, and the graphical data is returned for all windows of that application. In another embodiment of this disclosure, the libraries have independent components for each word-size (32- or 64-bit systems) to wrap 32- and 64-bit systems accordingly.

In one embodiment of the invention, refresh call and paint window calls are used to ensure the GPU is continuously rendering a target window. In another embodiment of the invention, the entire system can be turned on and off at will. In another embodiment of the invention, the entire system is constantly running.

For simplicity sake, the above description was chosen to follow one target window through the system, but the invention also includes systems with a plurality of target windows. Similarly, exemplary embodiments described above as applying to a window also apply to other graphical objects to the extent to which the other graphical objects share the necessary features of a window. Similarly, because windows are graphical objects, exemplary embodiments described above as applying to a graphical object also apply to windows.

The design and functionality described in this application is intended to be exemplary in nature and is not intended to limit the instant disclosure in any way. Those having ordinary skill in the art will appreciate that the teachings of the disclosure may be implemented in a variety of suitable forms, including those forms disclosed herein and additional forms known to those having ordinary skill in the art. For example, one skilled in the art will recognize that executable instructions may be stored on a non-transient, computer-readable storage medium, such that when executed by one or more processors, causes the one or more processors to implement the method described above.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments of this technology are described above with reference to block and flow diagrams of computing devices and methods and/or computer program products according to example embodiments of the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments of this disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computer-implemented method comprising:
generating, via a processor, a proxy object within an operating system, wherein the operating system comprises a window manager and a graphics framework;
registering, via the processor, a target object;
instructing the operating system, via the processor, to map graphical information corresponding to the target object to the proxy object;
intercepting, via the processor, the graphical information corresponding to the target object;
storing, via the processor, a copy of the graphical information corresponding to the target object.

2. The computer-implemented method of claim 1 further comprising exporting the stored copy of the graphical information corresponding to the target object.

3. The computer-implemented method of claim 1 further comprising inserting, via the processor, instructions into the operating system to create the proxy object, register the target object, instruct the operating system to map graphical information corresponding to the target object to the proxy object, intercept the graphical information corresponding to the target object, and store the copy of the graphical information corresponding to the target object.

4. The computer-implemented method of claim 1 wherein the proxy object is a top-level window within a graphical user interface (GUI).

5. The computer-implemented method of claim 1 wherein the proxy object is a ghost window.

6. The computer-implemented method of claim 5 wherein the ghost window comprises a graphical object comprising a ghost-window client-space image and ghost-window vertex information; and
wherein the ghost-window vertex information comprises a position of the ghost window and a size of the ghost window and wherein the position of the ghost window and the size of the ghost window define the ghost window to be at least partially within a visible area of a display device.

7. The computer-implemented method of claim 6 wherein the ghost-window further comprises ghost-window shader information wherein the ghost-window shader information defines a transparency of the ghost window and wherein the transparency of the ghost window is greater than 50% and less than 100%.

8. The computer-implemented method of claim 7 wherein the transparency of the ghost window is greater than 99%.

9. The computer-implemented method of claim 1 wherein registering the target object comprises adding a unique identifier for the target object to a target registry, wherein the target registry comprises a list of unique identifiers.

10. The computer-implemented method of claim 6 wherein instructing the operating system to map graphical information corresponding to the target object to the proxy object comprises:
generating a location for the target object within the ghost window;
generating a size for the target object within the ghost window; and
wherein at least one of the following is unique:
(i) the location for the target object within the ghost window; and
(ii) the size for the target object within the ghost window.

11. The computer-implemented method of claim 1 wherein intercepting the graphical information corresponding to the target object comprises copying a function call from the window manager to the graphics framework to a capture buffer; and
identifying the graphical information corresponding to the target object within the function call from the window manager to the graphics framework, based on at least one of:
a unique position within ghost window, and
a size of the target object within the ghost window.

12. The computer-implemented method of claim 1 wherein the graphical information corresponding to the target object comprises an image corresponding to the target object.

13. A computer system comprising:
memory comprising executable instructions; and
a processor operatively connected to the memory, the processor configured to execute the executable instructions in order to effectuate a method comprising:
generating, via a processor, a proxy object within an operating system, wherein the operating system comprises a window manager and a graphics framework;
registering, via the processor, a target object;
instructing the operating system, via the processor, to map graphical information corresponding to the target object to the proxy object;
intercepting, via the processor, the graphical information corresponding to the target object;
storing, via the processor, a copy of the graphical information corresponding to the target object.

14. The computer system of claim 13 wherein the processor is configured to execute the executable instructions in order to effectuate the method further comprising:
exporting the stored copy of the graphical information corresponding to the target object.

15. The computer system of claim 13 wherein the processor is configured to execute the executable instructions in order to effectuate the method further comprising:
inserting, via the processor, instructions into the operating system to create the proxy object, register the target object, instruct the operating system to map graphical information corresponding to the target object to the proxy object, intercept the graphical information corresponding to the target object, and store the copy of the graphical information corresponding to the target object.

16. The computer system of claim 13 wherein the proxy object a top-level window within a graphical user interface (GUI).

17. The computer system of claim 13 wherein the proxy object is a ghost window.

18. The computer system of claim 17 wherein the ghost window comprises a graphical object comprising a ghost-window client-space image and ghost-window vertex information; and
wherein the ghost-window vertex information comprises a position of the ghost window and a size of the ghost window and wherein the position of the ghost window and the size of the ghost window define the ghost window to be at least partially within a visible area of a display device.

19. The computer system of claim 18 wherein the ghost-window further comprises ghost-window shader information wherein the ghost-window shader information defines a transparency of the ghost window and wherein the transparency of the ghost window is greater than 50% and less than 100%.

20. The computer system of claim 19 wherein the transparency of the ghost window is greater than 99%.

21. The computer system of claim 13 wherein registering the target object comprises adding a unique identifier for the target object to a target registry, wherein the target registry comprises a list of unique identifiers.

22. The computer system of claim 18 wherein instructing the operating system to map graphical information corresponding to the target object to the proxy object comprises:
generating a location for the target object within the ghost window;
generating a size for the target object within the ghost window; and
wherein at least one of the following is unique:
(i) the location for the target object within the ghost window; and
(ii) the size for the target object within the ghost window.

23. The computer system of claim 13 wherein intercepting the graphical information corresponding to the target object comprises copying a function call from the window manager to the graphics framework to a capture buffer; and
identifying the graphical information corresponding to the target object within the function call from the window manager to the graphics framework based on at least one of:
a unique position within ghost window, and
a size of the target object within the ghost window.

24. The computer system of claim 13 wherein the graphical information corresponding to the target object comprises an image corresponding to the target object.

25. A non-transitory computer-readable medium comprising executable instructions that when executed by a processor cause the processor to effectuate a method comprising:
generating a proxy object within an operating system, wherein the operating system comprises a window manager and a graphics framework;
registering a target object;
instructing the operating system to map a copy of graphical information corresponding to the target object to the proxy object;
intercepting the graphical information corresponding to the target object; and
storing a copy of the graphical information corresponding to the target object.
